(19) United States
(12) Patent Application Publication
(10) Pub. No.: US 2006/0224802 A1
(43) Pub. Date: Oct. 5, 2006

(54) Control system

(75) Inventor: Yoshihiro Ida, Tokyo (JP)

Correspondence Address: EDWARDS & ANGELL, LLP, P.O. BOX 55874, BOSTON, MA, 02205, US

(73) Assignee: Yokogawa Electric Corporation, Tokyo (JP)

(21) Appl. No.: 11/378,132

(22) Filed: Mar. 16, 2006

(30) Foreign Application Priority Data
Mar. 17, 2005 (JP) P.2005-076525

(51) Int. Cl. H04L 12/28

(52) U.S. Cl. 710/100

(57) ABSTRACT

A control system an upper apparatus connected to a control bys, an OPC server connected to a communication bus, an OPC communication station connected to the control bus and the communication bus, and an engineering station connected to the control bus and the communication bus. The upper apparatus accesses the OPC server manages via the OPC communication station. The engineering station acquires data from the OPC server, and generates engineering data accessible by the upper apparatus and the OPC communication station based on the acquired data.

### CROSS-REFERENCE TO RELATED APPLICATIONS

This application is based upon and claims the benefit of priority from the prior Japanese Patent Applications No. 2005-076525, filed on Mar. 17, 2005, the entire contents of which are incorporated herein by reference.

### BACKGROUND OF THE INVENTION

1. Field of the Invention

The present invention relates to a control system having an OPC communication station connected between a control bus to which an upper apparatus is connected and a communication bus to which an OPC server is connected such that the upper apparatus have access to data that the OPC server manages via the OPC communication station.

2. Description of the Related Art

JP-A-2004-221852 is related to the control system in which the upper apparatus has access to the data that the OPC server manages via the OPC communication station.

JP-A-2004-221852 is referred to as a related art.

FIG. 9 is a functional block diagram showing a configurative example of the control system in the related art. A reference 1 denotes an upper apparatus of the distributed control system, which is connected to a control bus 2. A reference 3 is a control station that is also connected to the control bus 2 and holds communication with the upper apparatus 1 to execute control the equipments in the plant.

References 4 and 5 denote an OPC server that constitutes a subsystem based on the OPC standard, respectively. These OPC servers 4, 5 are connected to a general-purpose communication bus 6 as typified by the Ethernet (registered trademark), and hold communication with field equipments 9 and 10 via private buses 7 and 8 respectively to collect and set data of these equipments.

In JP-A-2004-221852, in order to build up the integrated management environment that permits the upper apparatus 1 of the distributed control system to have access to the data that the OPC server manages via the OPC server of the subsystem and monitor the operation, such a configuration has been proposed that an OPC communication station 11 connected between the control bus 2 and the general-purpose communication bus 6 is provided.

Normally, in many cases the engineering of the distributed control system and the subsystem is offered from different venders. Therefore, in order to build up such integrated management environment, a data file in which a format of OPC management data of the subsystem is converted into a data format that the upper apparatus 1 can utilize must be generated, and then the data file must downloaded in the upper apparatus 1 and the OPC communication station 11.

A reference 12 denotes an engineering station connected to the control bus 2. A reference 121 denotes a builder installed into this engineering station. According to the manual inputting approach of an operator 13, the data file that is subject to the engineering by this builder is held in a database 122, and is downloaded in the upper apparatus 1 and the OPC communication station 11.

In order to form data files of respective subsystems necessary for the integral management in the distributed control system, considerable engineering man-hours are needed when the operator executes off-line operations by using only the builder 121 of the engineering station 12.

More particularly, the number of data pieces that the OPC server of the subsystem can manage is 100,000. For that purpose, the operator is requested to input manually 100,000 pieces of data definitions using a builder function while looking at the contents defined in respective OPC servers. According to this method, not only a massive amount of engineering man-hours is needed but also it is possible that an error, and the like occur frequently at a time of input. Thus, such a situation is forecasted that a large amount of useless man-hours will be consumed until the system can operate normally.

At the same time, in providing the engineering definition by the builder, the operator must also convert definition contents of the OPC servers into the data format of the distributed control system. Thus, there is the problem such that the operator must also have a thorough knowledge of the distributed control system.

### SUMMARY OF THE INVENTION

An object of the present invention is to provide a control system capable of reducing substantially engineering man-hours required for subsystem data, preventing the incorrect data input upon processing a huge amount of data, and reducing complicatedness of the operation required for converting contents of the data definition.

The invention provides a control system, having an upper apparatus connected to a control bys; an OPC server connected to a communication bus; an OPC communication station connected to the control bus and the communication bus; and an engineering station connected to the control bus and the communication bus, wherein the upper apparatus accesses the OPC server manages via the OPC communication station, and the engineering station acquires data from the OPC server, and generates engineering data accessible by the upper apparatus and the OPC communication station based on the acquired data.

In the control system, the engineering station has an OPC browse calling section which calls an OPC browse function provided to the OPC server based on an OPC standard.

In the control system, the engineering station has an importing section which acquires a CSV data file output from the OPC server.

In the control system, the engineering station has an information collecting section which saves data acquired by the OPC browse calling section or the importing section as a file.

In the control system, the engineering station has an automatic generating section which converts data collected by the information collecting section into a data format accessible by the upper apparatus and the OPC communication station under an automatic generating rule.

In the control system, the engineering station has a data complementing section which complements data generated by the automatic generating section with additional information as necessary.

In the control system, the engineering station saves data generated by the automatic generating section and has an engineering database which is loaded into the upper apparatus and the OPC communication station.

The following advantages can be achieved by the control system according to the present invention.

Since the function of the OPC browse provided to the OPC server based on the OPC standard is called to cooperate with this control system, the definition data can be collected automatically from the OPC server independent of the vender of the OPC server, and then the definition file of the distributed control system can be automatically generated.

Since the automatic generation executed under predetermined generation rules is used, the knowledge about the tag information, etc. of the distributed control system is not needed unlike the related art, and thus the operation of converting a huge amount of data can be executed without error based on a knowledge of a simple operation method only.

Since the automatic generation can be executed irrespective of an amount of data, the man-hour required to form the file defined manually by using the builder in the related art can be reduced remarkably.

Since the number of object data is massive, the manual input error can be prevented.

### BRIEF DESCRIPTION OF THE DRAWINGS

FIG. 1 is a functional block diagram showing an embodiment of a control system to which the present invention is applied;

FIG. 2 is a view showing an OPC Browse List Dialog screen started by an engineering station;

FIG. 3 is a view showing an OPC Browse Execute Dialog screen;

FIG. 4 is a view showing an AutoGenerate Dialog screen used to execute an automatic generation based on data attributes of DA information;

FIG. 5 is a view showing an AutoGenerate Dialog screen used to execute an automatic generation based on data attributes of A&E information;

FIG. 6 is a contrastive table showing rules applied to automatically generate a tag of a distributed control system from item names of DA data;

FIG. 7 is a contrastive table showing rules applied to automatically generate an event filter of the distributed control system from item names of A&E data;

FIG. 8 is a view showing a Browse Import Dialog screen; and

FIG. 9 is a functional block diagram showing an example of a control system in the related art.

### DETAILED DESCRIPTION OF THE PREFERRED EMBODIMENTS

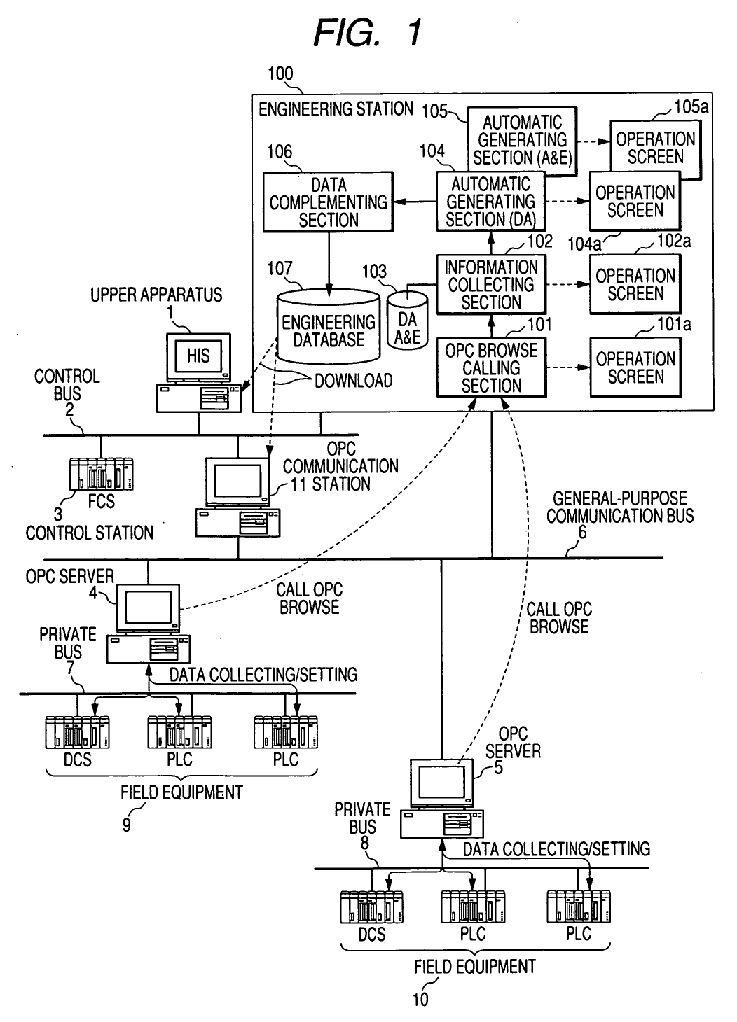

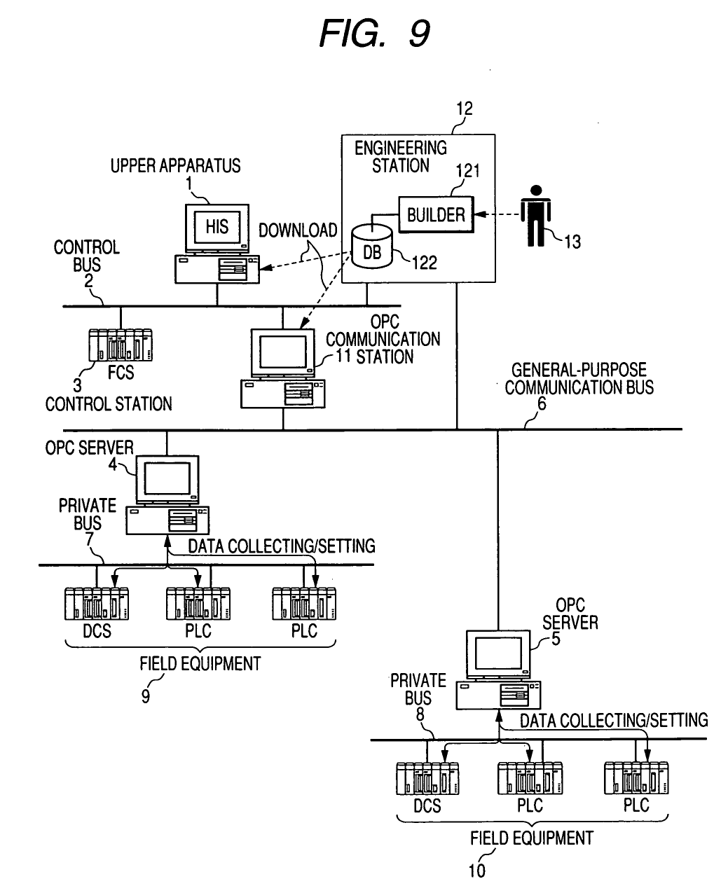

An embodiment according to the present invention will be explained in detail with reference to the drawings hereinafter. FIG. 1 is a functional block diagram showing an embodiment of a control system to which the present invention is applied. The same symbols are affixed to the same elements as those in the above-explained system as the related art explained in FIG. 9, and their explanation will be omitted herein. The characteristic portion of the present invention will be explained hereunder.

In FIG. 1, a reference 100 denotes an engineering station constituting the characteristic portion of the present invention, which is connected to both the control bus 2 and the general-purpose communication bus 6 and holds communication with the OPC servers 4, 5 of the subsystem.

In the engineering station 100, a reference 101 denotes an OPC browse calling section, and 101a denotes its operation screen. A reference 102 denotes an information collecting section that collects called data every DA (Data Access) and A&E (Alarm & Event) information and saves such data in a database 103. A reference 102a denotes its operation screen.

A reference 104 denotes an automatic generating section that converts DA information into the data format of the distributed control system under the generation rule. A reference 104a denotes its operation screen. A reference 105 also denotes an automatic generating section that converts A&E information into the data format of the distributed control system under the generation rule. A reference 105a denotes its operation screen.

A reference 106 denotes a data complementing section that complements the data generated by the automatic generating section 104 and 105 with additional information peculiar to the distributed control system, which are not attached to the subsystem, as the case may be, and saves resultant data in an engineering database 107. The saved engineering data are downloaded in the upper apparatus 1 and the OPC communication station 11.

A feature of the present invention resides in that the DA definition information and the A&E definition information are collected directly from the environment of the OPC servers, which have already been defined and operated, by using the OPC browse as one of interfaces that are normalized by OPC, then the collected information are converted into the data format which the distributed control system can have access to in accordance with the user's variable generation rule, and then necessary information are complemented with the converted information.

Then, operations of respective section will be explained with reference to corresponding operation screens hereunder.

(1) OPC Browse Calling Section 101

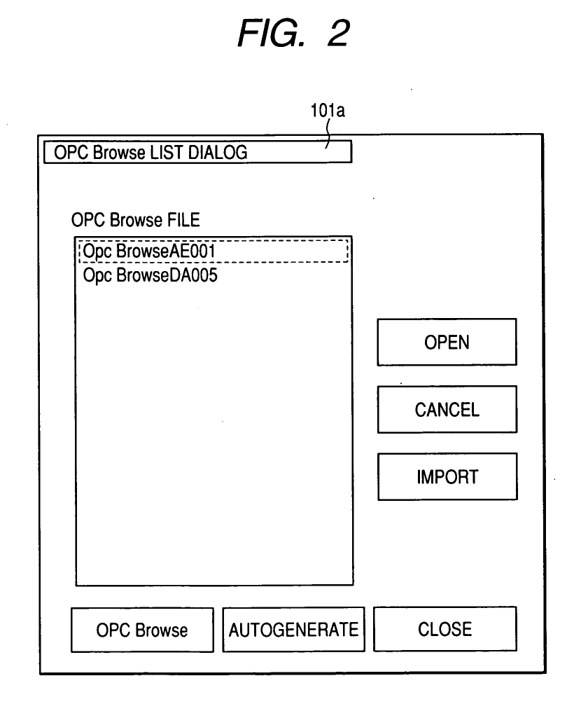

FIG. 2 is an OPC Browse List Dialog screen started by the engineering station 100. File names of the DA information and the A&E information that have already been prepared as files are displayed on this screen, and the operator can open these files. Also, the operator can execute respective processes of OPC browse, AutoGenerate, and Import via this initial screen.

(2) Information Collecting Section 102

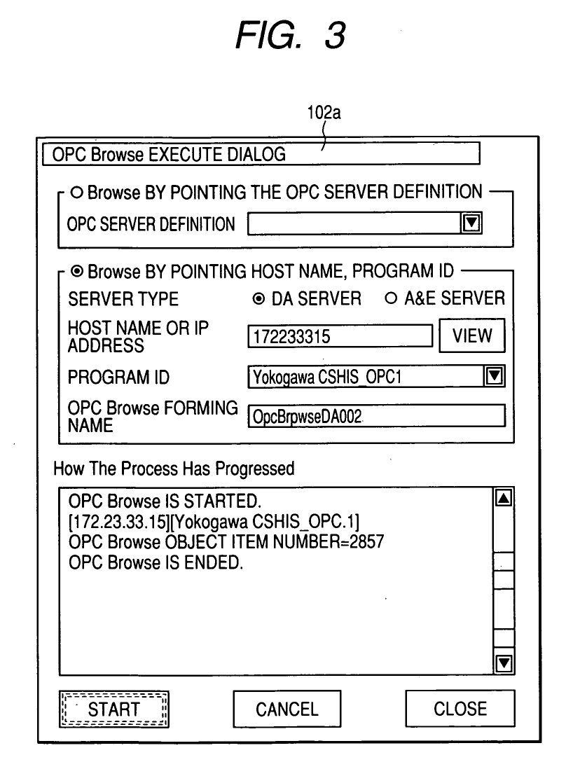

FIG. 3 is an OPC Browse Execute Dialog screen started when a button of the OPC browse on the bottom of the OPC Browse List Dialog screen in FIG. 2 is clicked. When a start button is clicked after the file name containing host name, server type, program ID, and collected data of the OPC server as the object from which the OPC browse is called is pointed, the DA information and the A&E information are collected automatically from the pointed OPC server, and then these information are saved in the database 103 as the pointed file name. In this case, it is feasible to give the OPC server definition previously in pointing the connection destination.

(3) Automatic Generating Section 104 (DA Information), 105 (A&E Information)

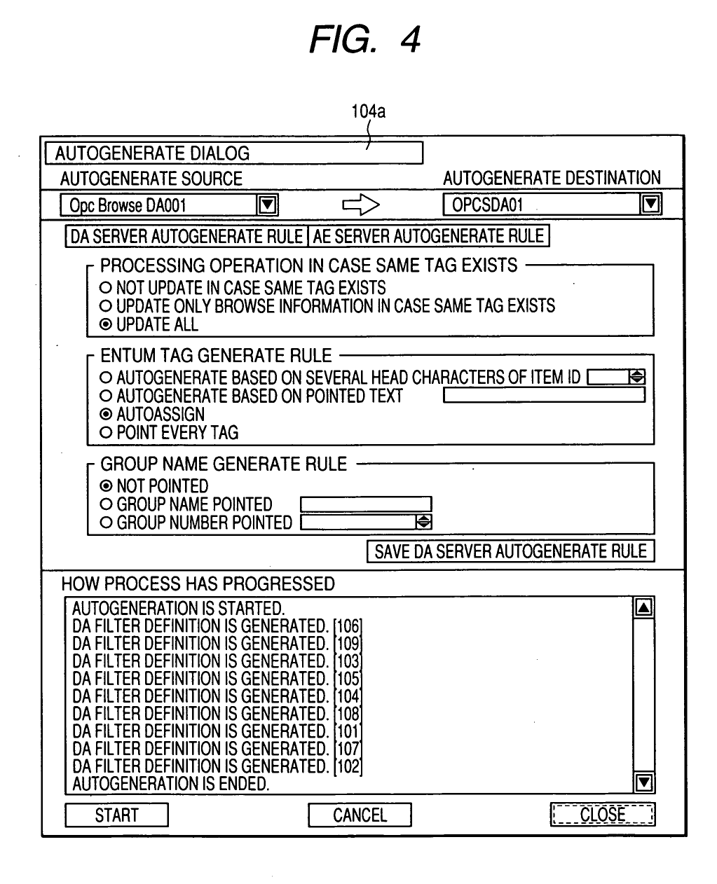

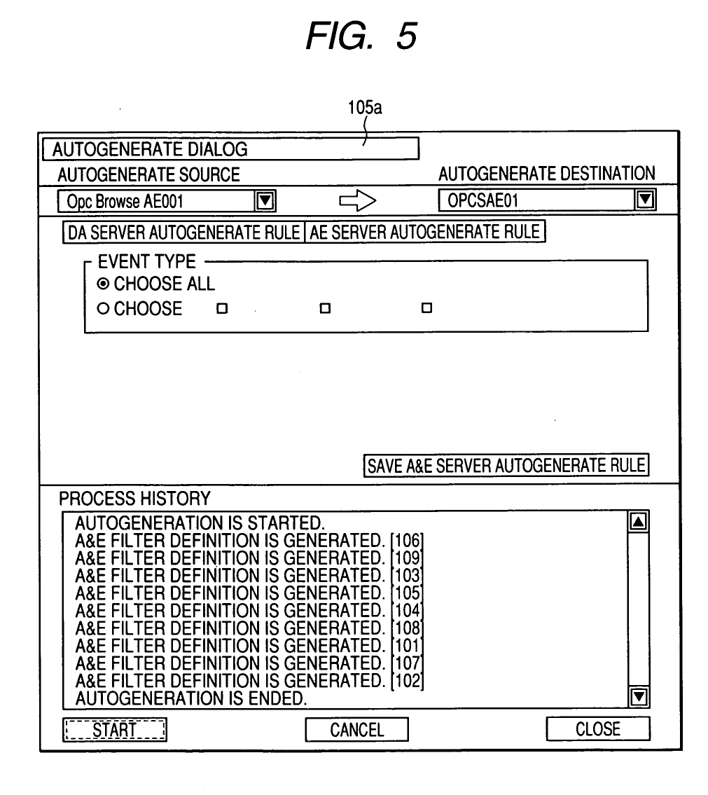

FIG. 4 is an AutoGenerate Dialog screen used to execute an automatic generation based on data attributes of the saved DA information. FIG. 5 is an AutoGenerate Dialog screen used to execute an automatic generation based on data attributes of the saved A&E information.

The automatic generation is started by pointing selectively the DA Server AutoGenerate Rule and the AE Server AutoGenerate Rule on the screen respectively and then clicking a Start button on the bottom of the screen. It is displayed on the screen how the process has progressed.

(4) Data Complementing Section 106

Data necessary for the tag information require for the distributed control system are complemented by the automatic generation method. Also, a model name of the instrument used in a face plate required to monitoring the operation in the upper apparatus 1 is assigned to meet to the data type that is defined in the OPC server. These processes are executed in unit of one piece of data to assign one tag to one piece of data, and these processes are applied to overall data. As a result, engineering data files are automatically generated in the engineering database 107.

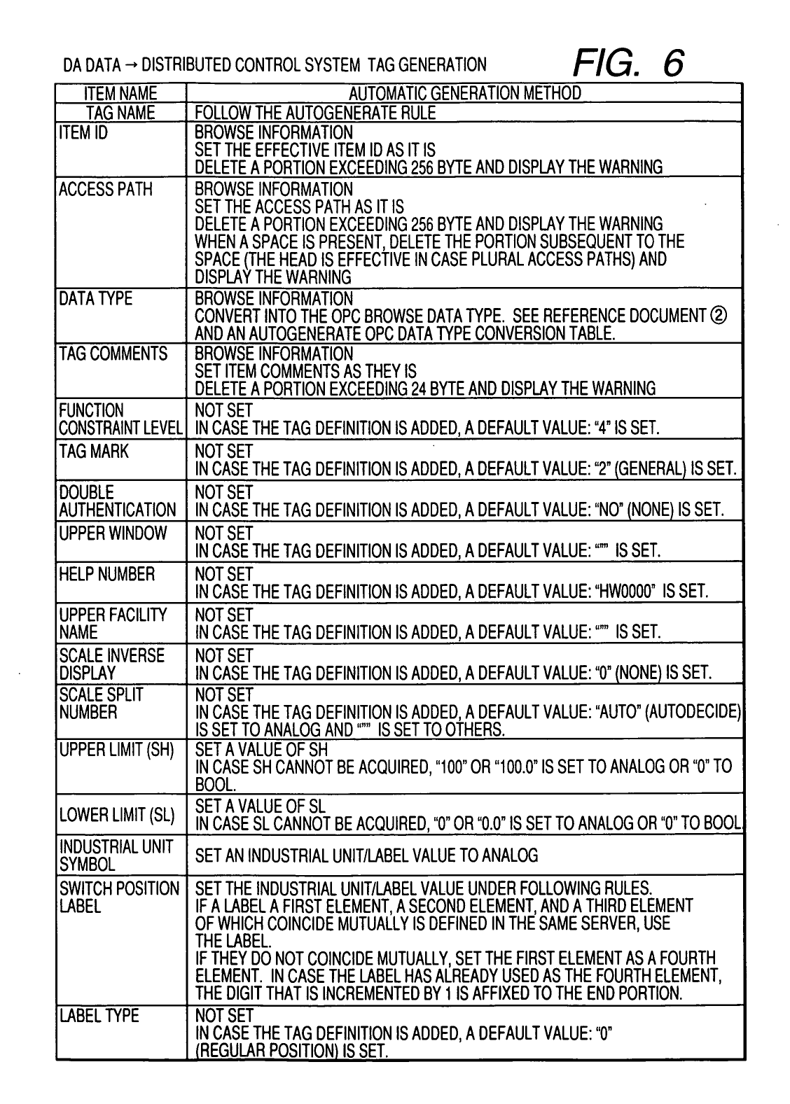

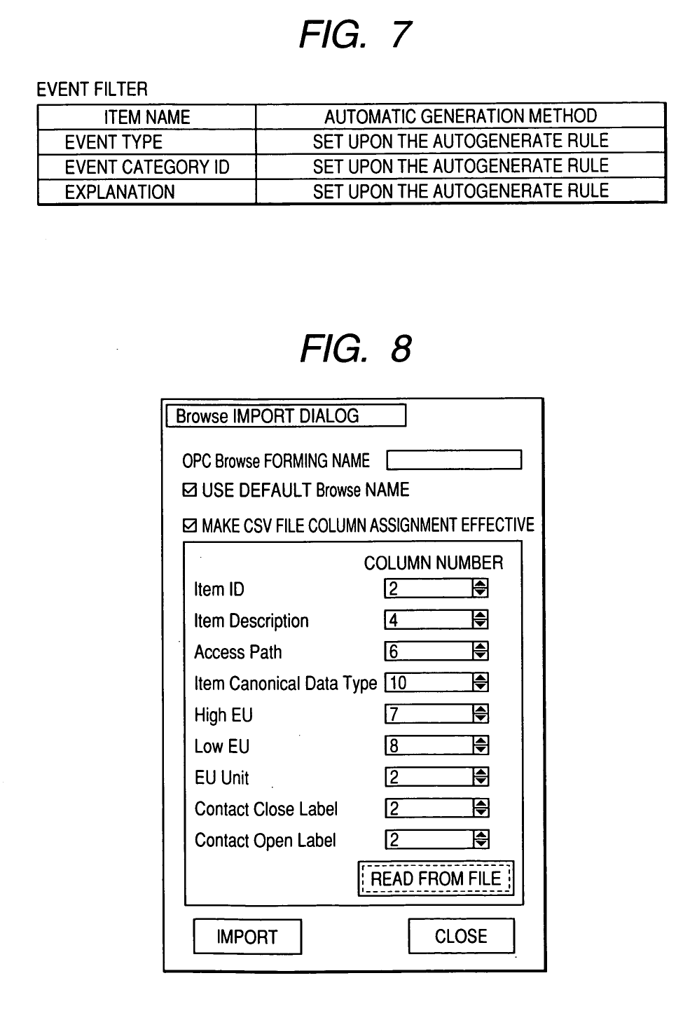

FIG. 6 is a contrastive table showing rules applied to automatically generate a tag of the distributed control system from item names of the DA data. FIG. 7 is a contrastive table showing rules applied to automatically generate an event filter of the distributed control system from item names of the A&E data.

In the engineering station 100, Generation (process of forming the database for the upper apparatus) and Load (transfer the data file to the upper apparatus 1 and the OPC communication station 11) are applied to the automatically generated file. Thus, the data in the OPC server can be operated/monitored from the upper apparatus 1 via the OPC communication station 11.

In the embodiment of the present invention explained above, the approach of calling/acquiring the data that the OPC server manages by using the OPC browse and automatically generating the file is shown. But the definition information in the OPC server can be collected by using an Import function given in the OPC Browse List Dialog shown in FIG. 2.

The result obtained by importing the OPC server definition files (Most of the OPC servers possess a function of outputting the definition contents into the files in the CSV format. In this case, respective data elements and their arrangement in the file are different according to the vender.) brings about the same result as that obtained by the OPC browse. Thus, the automatic generation can be executed based on the collected data.

FIG. 8 is a Browse Import Dialog screen started when an Import button is operated. This dialog defines mapping information of respective elements required to shape the file format to be imported into the field configuration that is similar to the file of the result obtained by the OPC browse.

As the result of file import, the file output from the OPC server (import object file) is generated in the same format as the OPC browse result file according to this definition. The generated file acts as the source object file of the automatic generation in the automatic generating section, and the engineering data can be automatically generated like the data collected by the OPC browse. The data collection by using the Import function is effective in the environment in which the engineering station 100 is not connected to the OPC server via the general-purpose communication bus 6.

What is claimed is:

1. A control system, comprising:
an upper apparatus connected to a control bys;
an OPC server connected to a communication bus;
an OPC communication station connected to the control bus and the communication bus; and
an engineering station connected to the control bus and the communication bus,
wherein the upper apparatus accesses the OPC server manages via the OPC communication station, and
the engineering station acquires data from the OPC server, and generates engineering data accessible by the upper apparatus and the OPC communication station based on the acquired data.

2. The control system according to claim 1,
wherein the engineering station has an OPC browse calling section which calls an OPC browse function provided to the OPC server based on an OPC standard.

3. The control system according to claim 1,
wherein the engineering station has an importing section which acquires a CSV data file output from the OPC server.

4. The control system according to claim 2,
wherein the engineering station has an information collecting section which saves data acquired by the OPC browse calling section as a file.

5. The control system according to claim 3,
wherein the engineering station has an information collecting section which saves data acquired by the importing section as a file.

6. The control system according to claim 4,
wherein the engineering station has an automatic generating section which converts data collected by the information collecting section into a data format accessible by the upper apparatus and the OPC communication station under an automatic generating rule.

7. The control system according to claim 5,
wherein the engineering station has an automatic generating section which converts data collected by the information collecting section into a data format accessible by the upper apparatus and the OPC communication station under an automatic generating rule.

8. The control system according to claim 6,
wherein the engineering station has a data complementing section which complements data generated by the automatic generating section with additional information as necessary.

9. The control system according to claim 7,
wherein the engineering station has a data complementing section which complements data generated by the automatic generating section with additional information as necessary.

10. The control system according to claim 6,
wherein the engineering station saves data generated by the automatic generating section and has an engineering database which is loaded into the upper apparatus and the OPC communication station.

11. The control system according to claim 7,
wherein the engineering station saves data generated by the automatic generating section and has an engineering database which is loaded into the upper apparatus and the OPC communication station.
